(19) United States
(12) Patent Application Publication
(10) Pub. No.: US 2017/0041766 A1
(43) Pub. Date: Feb. 9, 2017

(54) MEDIA ACCESS CONTROL SEGMENTATION AND PACKET DATA CONVERGENCE PROTOCOL DELIVERY NOTIFICATION WITH ENHANCED COMPONENT CARRIERS

(71) Applicant: QUALCOMM Incorporated, San Diego, CA (US)

(72) Inventors: Madhavan Srinivasan Vajapeyam, San Diego, CA (US); Siddhartha Mallik, San Diego, CA (US); Jun Wang, Poway, CA (US); Aleksandar Damnjanovic, Del Mar, CA (US); Taesang Yoo, Riverside, CA (US); Jing Sun, San Diego, CA (US); Yongbin Wei, La Jolla, CA (US)

(21) Appl. No.: 15/190,040

(22) Filed: Jun. 22, 2016

Related U.S. Application Data
(60) Provisional application No. 62/201,506, filed on Aug. 5, 2015.

(51) Int. Cl. H04W 4/06; H04W 76/04; H04L 5/00

(52) U.S. Cl. CPC H04W 4/06; H04L 5/0055; H04W 76/046; H04L 5/0007

(57) ABSTRACT

Methods, systems, and devices for wireless communication are described. A transmitting device, which may be configured without a radio link control (RLC) layer, may receive a packet data convergence protocol (PDCP) protocol data unit (PDU) at a media access control (MAC) layer. The device may then generate a set of transport blocks at the MAC layer using the PDCP PDU and transmit them over a wireless connection. A receiving device, which may also be configured without an RLC layer, may receive the transport blocks at the MAC layer, generate a MAC service data unit (SDU), and convey the MAC SDU to a PDCP. In some cases, the receiving device may then send an acknowledgement (ACK) or negative acknowledgement (NACK) for each transport block that includes a portion of the PDCP PDU, and the transmitting device may indicate to the PDCP layer whether the PDCP PDU was successfully received.

### CROSS REFERENCES

The present application for patent claims priority to U.S. Provisional Patent Application No. 62/201,506 by Vajapeyam et al., entitled “Media Access Control Segmentation and Packet Data Convergence Protocol Delivery Notification with Enhanced Component Carriers,” filed Aug. 5, 2015, assigned to the assignee hereof.

### BACKGROUND

The following relates generally to wireless communication, and more specifically to media access control (MAC) segmentation and packet data convergence protocol (PDCP) delivery notification with enhanced component carriers (eCCs).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple access communications system may include a number of base stations, each simultaneously supporting communication for multiple communication devices, which may be otherwise known as user equipment (UE).

In some cases, a wireless system may utilize multiple protocol layers to process wireless transmissions. For example, a system may be based on functions divided into a PDCP layer (e.g., for header compression and sequencing), a radio link control (RLC) layer (e.g., for error correction and segmentation/concatenation of packets), and a MAC layer (e.g., for multiplexing and error correction). One or more functions of the RLC layer may be redundant and may result in increased processing complexity and signaling overhead.

### SUMMARY

A transmitting device may support communication without a radio link control (RLC) layer, which may include receiving a packet data convergence protocol (PDCP) protocol data unit (PDU) at the media access control (MAC) layer. The device may generate a set of transport blocks at the MAC layer using the PDCP PDU and transmit them over a wireless connection. In some examples, the PDCP PDUs are segmented and portions of one PDCP PDU are mapped to different transport blocks. In some cases, a segmented portion of a PDCP PDU may be resegemented and mapped to still different transport blocks.

A receiving device, which may also support communication without an RLC layer, may receive the transport blocks at the MAC layer and generate a MAC service data unit (SDU). This may include identifying a segmented PDCP PDU and generating the MAC SDUs accordingly. The receiving device may then convey the MAC SDU to a PDCP. In some cases, the receiving device may then send an acknowledgement (ACK) or negative acknowledgement (NACK) for each transport block that includes a portion of the PDCP PDU. The transmitting device may receive the ACK/NACK, and forward an indication of whether the PDCP PDU was successfully received to the PDCP layer.

A method of wireless communication is described. The method may include receiving a first PDCP PDU at a MAC layer of a transmitter, generating a set of transport blocks at the MAC layer using the first PDCP PDU, and transmitting the set of transport blocks.

An apparatus for wireless communication is described. The apparatus may include means for receiving a first PDCP PDU at a MAC layer of a transmitter, means for generating a set of transport blocks at the MAC layer using the first PDCP PDU, and means for transmitting the set of transport blocks.

A further apparatus for wireless communication is described. The apparatus may include a processor, memory in electronic communication with the processor, and instructions stored in the memory and operable, when executed by the processor, to cause the apparatus to receive a first PDCP PDU at a MAC layer of a transmitter, generate a set of transport blocks at the MAC layer using the first PDCP PDU, and transmit the set of transport blocks.

A non-transitory computer-readable medium storing code for wireless communication is described. The code may include instructions executable to receive a first PDCP PDU at a MAC layer of a transmitter, generate a set of transport blocks at the MAC layer using the first PDCP PDU, and transmit the set of transport blocks.

In some examples of the method, apparatuses, or non-transitory computer-readable medium described herein, generating the set of transport blocks comprises generating a first transport block that comprises a first portion of the first PDCP PDU and a second transport block that comprises a second portion of the first PDCP PDU. Additionally or alternatively, some examples may include processes, features, means, or instructions for receiving a second PDCP PDU at the MAC layer of the transmitter, wherein one transport block of the set of transport blocks comprises the second PDCP PDU.

Some examples of the method, apparatuses, or non-transitory computer-readable medium described herein may further include processes, features, means, or instructions for receiving a second PDCP PDU at the MAC layer of the transmitter, wherein one transport block of the set of transport blocks comprises a portion of the first PDCP PDU and a portion of the second PDCP PDU. Additionally or alternatively, some examples may include processes, features, means, or instructions for storing information at the transmitter that indicates a mapping between each transport block of the set of transport blocks that comprises a portion of the first PDCP PDU.

Some examples of the method, apparatuses, or non-transitory computer-readable medium described herein may further include processes, features, means, or instructions for receiving at the MAC layer of the transmitter an ACK or NACK for each transport block of the set of transport blocks that comprises a portion of the first PDCP PDU, and indicate to a PDCP layer that the first PDCP PDU was successfully received or unsuccessfully received based at least in part on receiving the ACK or NACK. Additionally or alternatively, in some examples each transport block of the set of transport blocks comprises a header that indicates that the transport block comprises a PDCP PDU segment or a non-segmented PDCP PDU.

In some examples of the method, apparatuses, or non-transitory computer-readable medium described herein, the header indicates that the transport block comprises a PDCP PDU segment, and wherein the header comprises a tag number that identifies a complete PDCP PDU to which the PDCP PDU segment corresponds. Additionally or alternatively, in some examples the header indicates that the transport block comprises a PDCP PDU segment, and wherein the header comprises a segment number that identifies an ordering of the PDCP PDU segment with respect to other segments of the complete PDCP PDU.

In some examples of the method, apparatuses, or non-transitory computer-readable medium described herein, the segment number indicates an offset of the PDCP PDU segment relative to a beginning of the complete PDCP PDU. Additionally or alternatively, in some examples the header indicates that the transport block comprises a PDCP PDU segment, and wherein the header comprises a framing indicator that identifies the PDCP PDU segment as containing an initial portion, a middle portion, or a last portion of the complete PDCP PDU.

In some examples of the method, apparatuses, or non-transitory computer-readable medium described herein, generating the set of transport blocks comprises generating a first transport block that comprises a first portion of the first PDCP PDU and a second transport block that comprises a second portion of the first PDCP PDU, and generating a third transport block that comprises a first segment of the first portion of the first PDCP PDU and a fourth transport block that comprises a second segment of the first portion of the first PDCP PDU. Additionally or alternatively, in some examples the third and fourth transport blocks each comprise a header that indicates that they contain a segmented portion of the first PDCP PDU.

In some examples of the method, apparatuses, or non-transitory computer-readable medium described herein, the header of each transport block comprises a tag number that identifies the first portion of the first PDCP PDU. Additionally or alternatively, in some examples the header of each transport block comprises a segment number that identifies an ordering of the first and second segments of the first portion of the first PDCP PDU.

In some examples of the method, apparatuses, or non-transitory computer-readable medium described herein, the segment numbers indicate an offset relative to a beginning of the first portion of the first PDCP PDU. Additionally or alternatively, in some examples the header comprises a framing indicator that identifies a segment as containing an initial portion, one or more intermediate portions, or a last portion of the first PDCP PDU.

In some examples of the method, apparatuses, or non-transitory computer-readable medium described herein, the third transport block is generated based at least in part on a terminated hybrid automatic repeat request (HARQ) process or a changed modulation and coding scheme (MCS).

A method of wireless communication is described. The method may include receiving a set of transport blocks at a MAC layer of a receiver, generating a MAC SDU from the set of transport blocks, and transmitting the MAC SDU to a PDCP layer of the receiver.

An apparatus for wireless communication is described. The apparatus may include means for receiving a set of transport blocks at a MAC layer of a receiver, means for generating a MAC SDU from the set of transport blocks, and means for transmitting the MAC SDU to a PDCP layer of the receiver.

A further apparatus for wireless communication is described. The apparatus may include a processor, memory in electronic communication with the processor, and instructions stored in the memory and operable, when executed by the processor, to cause the apparatus to receive a set of transport blocks at a MAC layer of a receiver, generate a MAC SDU from the set of transport blocks, and transmit the MAC SDU to a PDCP layer of the receiver.

A non-transitory computer-readable medium storing code for wireless communication is described. The code may include instructions executable to receive a set of transport blocks at a MAC layer of a receiver, generate a MAC SDU from the set of transport blocks, and transmit the MAC SDU to a PDCP layer of the receiver.

In some examples of the method, apparatuses, or non-transitory computer-readable medium described herein, generating the MAC SDU comprises identifying a first portion of the MAC SDU in a first transport block of the set of transport blocks and a second portion of the MAC SDU in a second transport block of the set of transport blocks. Additionally or alternatively, in some examples the first portion of the MAC SDU is identified based at least in part on a header of the first transport block and the second portion of the MAC SDU is identified based at least in part on a header of the second transport block.

In some examples of the method, apparatuses, or non-transitory computer-readable medium described herein, the headers of the first and second transport blocks each comprise a tag number that identifies the MAC SDU. Additionally or alternatively, in some examples the headers of the first and second transport blocks comprise segment numbers that identify an ordering of the first and second portions of the MAC SDU.

In some examples of the methods, apparatuses, or non-transitory computer-readable medium described herein, the header of the first or second transport block comprises an indicator of an offset of the first portion or the second portion of the MAC SDU relative to a beginning of the MAC SDU or an indicator that identifies an initial portion, one or more intermediate portions or a last portion of the MAC SDU. Additionally or alternatively, in some examples the header of the first or second transport block comprises and indication that the first portion or the second portion of the MAC SDU is a resegmented portion of the MAC SDU.

### BRIEF DESCRIPTION OF THE DRAWINGS

Aspects of the disclosure are described in reference to the following figures:

FIG. 1 illustrates an example of a wireless communications system that supports media access control (MAC) segmentation and packet data convergence protocol (PDCP) delivery notification with an enhanced component carriers (eCC) in accordance with various aspects of the present disclosure;

FIG. 2 illustrates an example of a wireless communications system that supports MAC segmentation and PDCP delivery notification with an eCC accordance with various aspects of the present disclosure;

FIG. 3 illustrates an example of a protocol stack that supports MAC segmentation and PDCP delivery notification with an eCC in accordance with various aspects of the present disclosure;

FIGS. 4 and 5 illustrate examples of MAC service data unit (SDU) segmentation and reassembly and PDCP delivery notification with an eCC in accordance with various aspects of the present disclosure;

FIGS. 6-8 show block diagrams of a wireless device or devices that support MAC segmentation and PDCP delivery notification with an eCC in accordance with various aspects of the present disclosure;

FIG. 9 illustrates a block diagram of a system including, a user equipment that supports MAC segmentation and PDCP delivery notification with an eCC in accordance with various aspects of the present disclosure;

FIG. 10 illustrates a block diagram of a system including, including a base station that supports MAC segmentation and PDCP delivery notification with an eCC in accordance with various aspects of the present disclosure; and

FIGS. 11-14 illustrate methods for MAC segmentation and PDCP delivery notification in accordance with various aspects of the present disclosure.

### DETAILED DESCRIPTION

Wireless systems may be configured without or may otherwise support communication without a radio link control (RLC) layer. In some wireless systems, an RLC layer may perform packet segmentation, resegmentation, and reassembly. For devices that support communication without an RLC layer, the actions associated with the RLC layer may be removed or handled at other layers. For example, some functions, such as reordering functionality, may be handled at the packet data convergence protocol (PDCP) layer. Other responsibilities may be handled at the media access control (MAC) layer. Thus, the MAC layer may perform segmentation, resegmentation, or reassembly of PDCP protocol data units (PDU), as well as scheduling and multiplexing. The MAC layer may also provide delivery notification to the PDCP layer. Performing RLC operations at the MAC layer may reduce transmission redundancy, signaling overhead and processing complexity, which may save power, improve the operation of low power, low complexity devices and increase packet throughput.

The MAC layer may also manage automatic repeat request (ARQ) and hybrid ARQ (HARQ) retransmission. In some cases, the MAC layer may include a variety of modes for transmission that may correspond to modes associated with the RLC layer. For example the MAC layer may include a reliable mode, a delay sensitive mode, and a transparent mode.

The MAC layer may also segment, resegment, and concatenate packets. A MAC receiver may detect the presence of a segmented service data unit (SDU) based on the header information of the segment. The receiver may wait until it receives all the segments correctly before delivering the reassembled SDU to the PDCP layer.

A resegmentation process may also be used, which may include retransmission of portions of data that were previously segmented, such that the portions of data may be segmented again. For example, portions of data may be resegmented in cases when the MAC layer decides to terminate a previous HARQ process.

Aspects of the disclosure introduced above are further described below in the context of an exemplary wireless communication system. Specific examples of a protocol stack and of MAC layer segmentation and reassembly are then described. These and other aspects of the disclosure are further illustrated by and described with reference to apparatus diagrams, system diagrams, and flowcharts that relate to MAC segmentation and PDCP delivery notification with an enhanced component carrier (eCC).

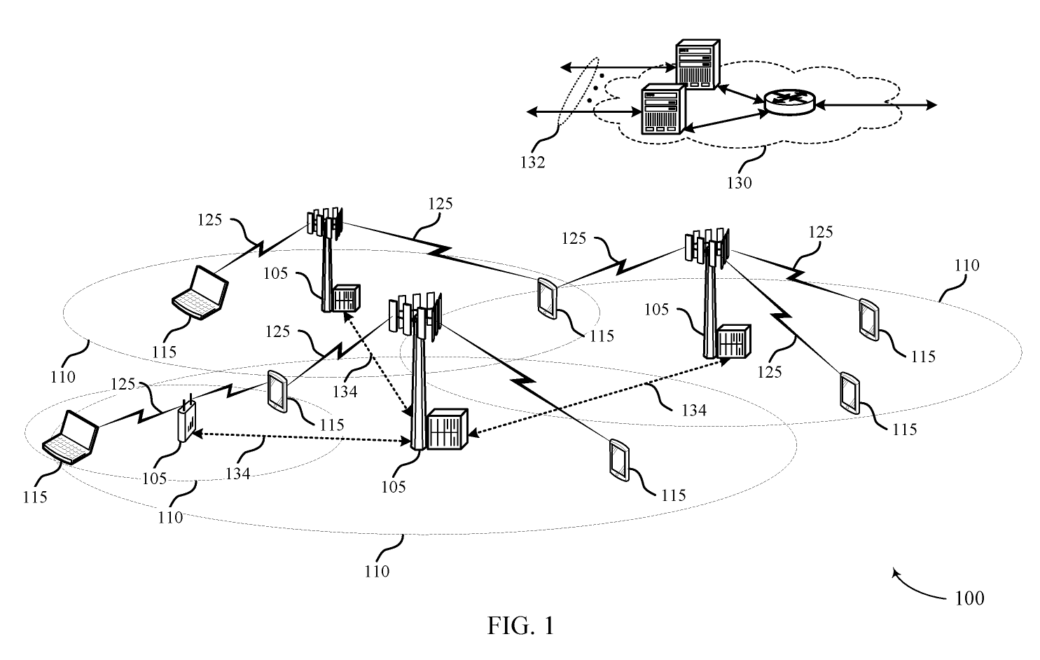

FIG. 1 illustrates an example of a wireless communications system 100 that supports MAC segmentation and PDCP delivery notification with an eCC in accordance with various aspects of the present disclosure. The wireless communications system 100 includes base stations 105, user equipment (UEs) 115, and a core network 130. In some examples, the wireless communications system 100 may be a Long Term Evolution (LTE)/LTE-Advanced (LTE-A) network. In some cases, wireless communications system 100 may utilize a protocol stack in which the MAC layer communicates directly with the PDCP layer and performs functions associated with the RLC layer.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

Wireless communications system 100 may be based on a layered protocol system, which may include an internet protocol (IP) layer, a PDCP layer, an RLC layer, a MAC layer, and a physical (PHY) layer. The PDCP layer may be responsible for receiving IP packets and performing header compression and decompression using, for instance, a robust header compression (ROHC) protocol. The PDCP layer may further be responsible for the transfer of data (user plane or control plane), maintenance of PDCP sequence numbers (SNs), and in-sequence delivery of upper layer PDUs to lower layers. The PDCP layer may also manage packets to avoid duplicates, cipher and decipher user plane data and control plane data, perform integrity protection and integrity verification of control plane data, and discard packets based on a timer-out timer.

An RLC layer, when used, may connect higher layers (e.g., the PDCP layer) to the lower layers (e.g., the MAC layer). An RLC entity in a base station 105 or a UE 115 may support transmission packet organization by monitoring transport block size (e.g., corresponding to the MAC layer transport block size). If an incoming data packet (i.e., a PDCP or radio resource control (RRC) SDU) is too big for transmission, the RLC layer may segment it into several smaller RLC PDUs. If the incoming packets are too small, the RLC layer may concatenate several of them into a single, larger RLC PDU. Each RLC PDU may include a header including information about how to reassemble the data. The RLC layer may also ensure that packets are reliably transmitted. The transmitter may keep a buffer of indexed RLC PDUs, and continue retransmission of each PDU until it receives the corresponding acknowledgement (ACK). In some cases, wireless communications system 100 may operate without an RLC layer, and one or more functions associated with the RLC layer may be performed by the MAC layer.

In some cases, the transmitter may send a Poll Request to determine which PDUs have been received and the receiver may respond with a Status Report. Unlike the MAC layer HARQ, RLC ARQ may not include a forward error correction function. An RLC entity may operate in one of three modes, in an acknowledged mode (AM), an unacknowledged mode (UM) or a transparent mode (TM). In AM, the RLC entity may perform segmentation/concatenation and ARQ. This mode may be appropriate for delay tolerant or error sensitive transmissions. In UM, the RLC entity may perform segmentation/concatenation but not ARQ. This mode may be appropriate for delay sensitive or error tolerant traffic (e.g., voice over Long Term evolution (VoLTE)). TM performs data buffering, but may not include either concatenation/segmentation or ARQ. TM may be used primarily for sending broadcast control information (e.g., the master information block (MD3) and system information blocks (SIBs)), paging messages, and RRC connection messages. Some transmissions may be sent without RLC (e.g., a random access channel (RACH) preamble and response).

In some cases, as described further below, a system may support communication without an RLC layer. In such cases, the MAC layer may perform some or all of the functions otherwise performed by the RLC layer. The MAC layer may also perform mapping between logical and transport channels, prioritize channels, perform dynamic scheduling, and provide error correction, such as HARQ. HARQ may be a method of ensuring that data is received correctly over a communication link 125 by performing a combination of error detection (e.g., using a cyclic redundancy check (CRC)), forward error correction (FEC), and retransmission (e.g., ARQ). HARQ may improve throughput at the MAC layer in poor radio conditions (e.g., signal-to-noise conditions).

In Incremental Redundancy HARQ, incorrectly received data may be stored in a buffer and combined with subsequent transmissions to improve the overall likelihood of successfully decoding the data. In some cases, redundancy bits are added to each message prior to transmission. This may be especially useful in poor conditions. In other cases, redundancy bits are not added to each transmission, but are retransmitted after the transmitter of the original message receives a negative acknowledgement (NACK) indicating a failed attempt to decode the information. The chain of transmission, response, and retransmission may be referred to as a HARQ process. In some instances, a limited number of HARQ processes may be used for a given communication link 125.

In some cases, wireless communications system 100 utilizes one or more eCCs. An eCC may be characterized by features that include: flexible bandwidth, different transmission time intervals (TTIs), or a modified control channel configuration. An eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum). An eCC characterized by flexible bandwidth may include bandwidth segments or narrowband regions that may be utilized by UEs 115 that are incapable of monitoring the whole bandwidth or that prefer to use a limited bandwidth (e.g., to conserve power).

An eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may include multiple hierarchical layers associated with the different TTI lengths. For instance, TTIs at one hierarchical layer may correspond to uniform 1 ms subframes, whereas in a second layer, variable length TTIs may correspond to bursts of short duration symbol periods. In some cases, a shorter symbol duration may also be associated with increased subcarrier spacing. In conjunction with the reduced TTI length, an eCC may utilize dynamic time division duplex (TDD) operation (i.e., it may switch from DL to UL operation for short bursts according to dynamic conditions.)

Flexible bandwidth and variable TTIs may be associated with a modified control channel configuration (e.g., an eCC may utilize an enhanced physical downlink control channel (ePDCCH) for DL control information). For example, some control channels of an eCC may utilize frequency-division multiplexing (FDM) scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional HARQ related control information. As described herein, systems that utilize eCCs may support communications without an RLC layer, which may simplify or reduce redundant operation between layers of the protocol stack for the system.

A transmitting device, such as a UE 115 or a base station 105, may receive a PDCP PDU at the MAC layer. The device may then generate a set of transport blocks at the MAC layer using the PDCP PDU and transmit them over a wireless connection. A receiving device, such as a UE 115 or a base station 105, may receive the transport blocks at the MAC layer, generate a MAC SDU, and convey the MAC SDU to a PDCP. In some cases, the receiving device may then send a HARQ ACK or NACK for each transport block that includes a portion of the PDCP PDU. The transmitter may receive the ACK/NACK and forward an indication of whether the PDCP PDU was successfully received to the PDCP layer.

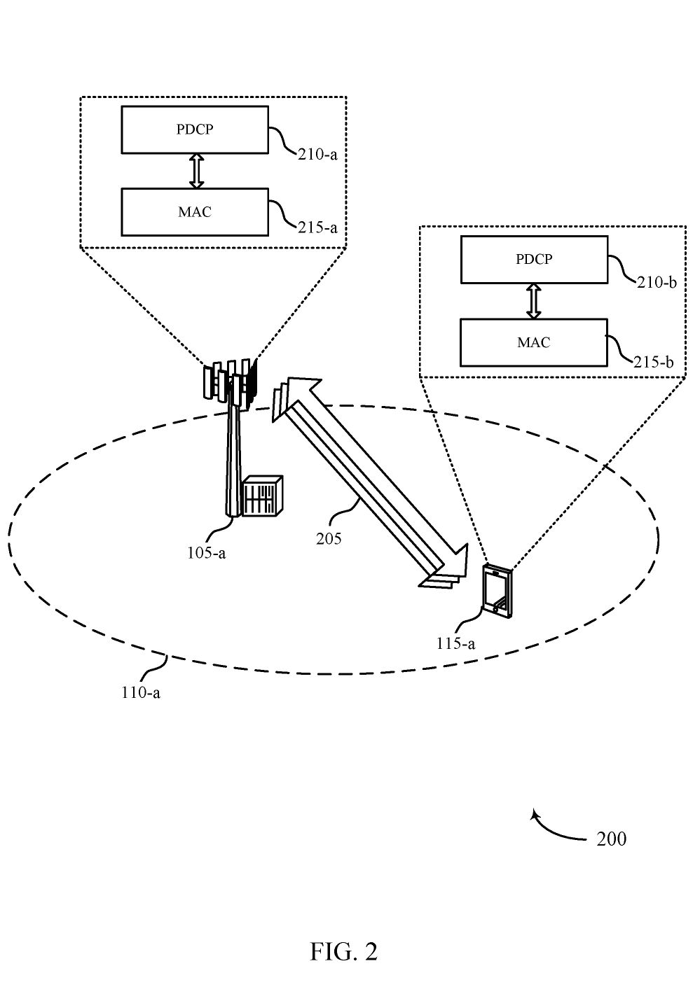

FIG. 2 illustrates an example of a wireless communications system 200 for MAC segmentation and PDCP delivery notification with an eCC in accordance with various aspects of the present disclosure. Wireless communications system 200 may include UE 115-a and base station 105-a, which may be examples of a UE 115 and abase station 105 described with reference to FIG. 1. UE 115-a and base station 105-a may communicate with one or several carriers 205 (including an eCC) and may utilize a protocol stack in which the PDCP layer 210 communicates directly with the MAC layer 215, and the MAC layer 215 performs functions associated with the RLC layer of some systems.

In some wireless systems, an RLC layer may perform packet segmentation, resegmentation, and reassembly. Wireless communications system 200 may support communications without an RLC layer, and the actions associated with the RLC layer may be removed or handled at other layers. For example, functions such as reordering may be handled at the PDCP layer 210. Other responsibilities may be handled at the MAC layer 215. The MAC layer 215 may perform some or all functions associated with scheduling and multiplexing. The MAC layer 215 may also perform procedures for such as delivery notification to the PDCP layer 210, segmentation of PDCP protocol data units (PDUs), and resegmentation of PCP PDUs.

The MAC layer 215 may also manage ARQ and HARQ retransmission. The MAC layer 215 may convey notification of delivery, which may include local ACK/NACK information based on HARQ feedback from transmitted MAC PDU, to the PDCP layer 210. For each MAC PDU, a MAC sender (such as UE 115-a or base station 105-a) may locally store information about the PDCP PDUs carried by the MAC PDU. Upon reception of an ACK or NACK signal for all transport blocks (TBs) corresponding to the PDCP PDU, the MAC layer 215 may notify the PDCP layer 210 of reception of the PDCP PDU.

The MAC layer 215 may include a variety of modes for transmission, which may replace similar modes otherwise associated with the RLC layer. For example, the MAC layer 215 may include a reliable mode, a delay sensitive mode, and a transparent mode. The reliable mode may enable more reliable delivery of packets. The delay sensitive mode may enable more immediate transmission of delay sensitive information. The transparent mode may enable a pass-through mode for signaling; meaning that the MAC layer 215 may not perform segmentation or guarantee delivery, for example.

For systems configured to operate without an RLC layer, such as wireless communications system 200, the MAC layer 215 may also segment, resegment, and concatenate packets. For example, a MAC layer 215 may support transmission of a PDCP PDU over multiple MAC PDUs (i.e., TBs). The transmission of a PDCP PDU over multiple MAC PDUs may be denoted as a segmentation operation. For each MAC SDU, a MAC sender may store the data of the TB carrying the MAC SDU. Upon reception of an ACK for each TB, the MAC may notify the PDCP layer of correct reception of the PDCP PDU. In a MAC PDU header, the sender may include for each segmented SDU contained in the PDU a segmentation flag (SF), a tag number, a segment number, and framing information. The SF may indicate whether segmentation is happening. The tag number may identify segments corresponding to the same SDU. The segment number may enable the receiver to assemble the segments in order or, alternatively, to use an offset number, in some cases in bytes. The framing information may indicate whether the first and last byte of the payload correspond to a segmented SDU.

A MAC receiver (e.g., either UE 115-a or base station 105-a) may detect the presence of segmented SDU based on the header information of a segment. The receiver may wait until it receives all the segments correctly before delivering the reassembled SDU to the PDCP layer. In some cases, the PDCP PDUs may be delivered out of order to the PDCP layer. Undelivered segments in a buffer may be discarded upon a timer expiration.

Resegmentation may consist of retransmission of portions of data that were previously segmented, such that the portions of data may be segmented again. The portions of data may be resegmented in cases when the MAC layer 215 decides to terminate a previous HARQ process, which may change the modulation and coding scheme. To identify a resegmented PDCP PDU, a MAC layer 215 of a transmitter may add resegmentation information in the PDCP header.

Resegmentation information may be in addition to the segmentation header information. The resegmentation information may include a resegmentation flag (RF), a tag number, segment number and framing information, a resegmentation offset, and a last segment flag. The resegmentation flag may indicate that resegmentation of previously segmented SDU occurs. The tag number, segment number, and framing information may include the same information as the corresponding segmented PDU. The resegmentation offset may be an offset, in bytes, of the starting position of the resegmented PDU within the original PDU. The last segment flag may identify the last portion of a resegmented PDU within a segmented PDU. The receiver may assemble received segments based on the sequence number and offset indication.

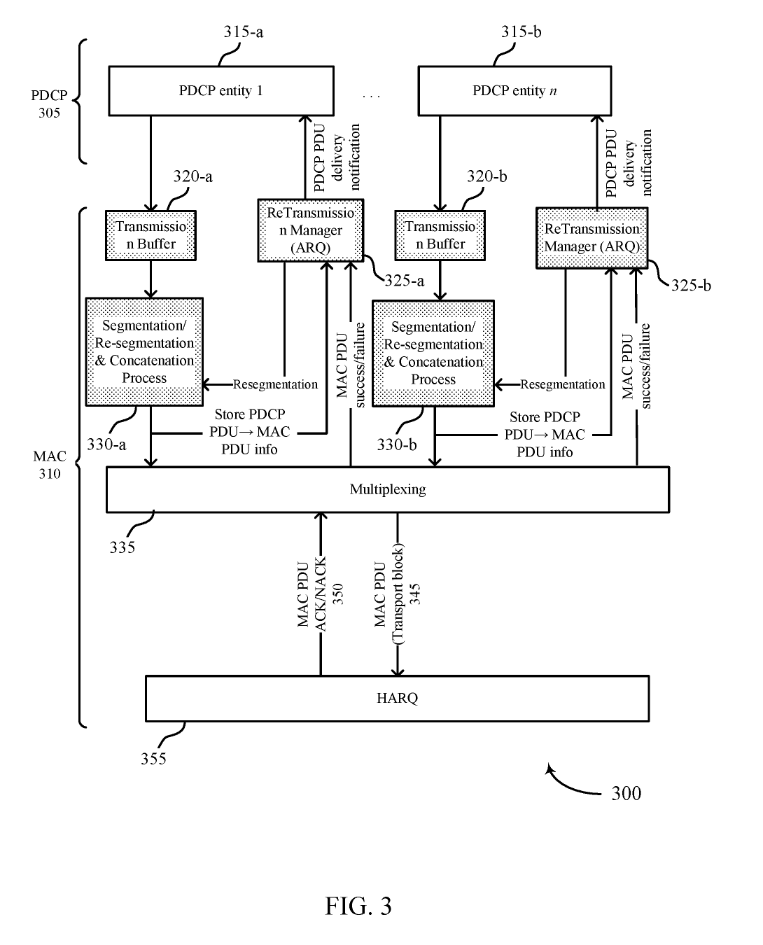

FIG. 3 illustrates an example of a protocol stack 300 that supports MAC segmentation and PDCP delivery notification with an eCC in accordance with various aspects of the present disclosure. Protocol Stack 300 may be used by a UE 115 or a base station 105 described with reference to FIGS. 1-2. Functions otherwise associated with an RLC layer in some wireless systems may be performed by the PDCP or MAC layers as illustrated.

Protocol Stack 300 may include a PDCP layer 305 and a MAC layer 310 and may describe the relationship between the PDCP layer 305 and the MAC layer 310. Specifically, delivery of packets and information between the two layers is depicted. The PDCP layer 305 may include multiple PDCP entities, such as first PDCP entity 315-a and last PDCP entity 315-b (i.e., the nth PDCP layer). First PDCP entity 315-a may send its information to transmission buffer 320-a in the MAC layer 310, and last PDCP entity 315-b may send its information to transmission buffer 320-b in the MAC layer 310. The MAC layer 310 may perform segmentation/resegmentation and concatenation process 330-a on the information in transmission buffer 320-a. Similarly, the MAC layer 310 may also perform segmentation/resegmentation and concatenation process 330-b on the information in last transmission buffer 320-a.

In some cases, the MAC layer 310 may perform ARQ or HARQ operation, where a portion of the information obtained after segmentation/resegmentation and concatenation process 330-a may be sent to retransmission manager 325-a and stored there. Similarly, a portion of the information obtained after segmentation/resegmentation and concatenation process 330-b may be sent to retransmission manager 325-b and stored there. If ARQ or HARQ information is performed, storing the information in retransmission manager 325-a may expedite the step of gathering appropriate information for transmission

When the information is passed through segmentation/resegmentation and concatenation process 330-a, it may be sent to a multiplexing process 335 to be multiplexed with other information passed through another segmentation/resegmentation and concatenation process. For example, information from segmentation/resegmentation and concatenation process 330-a may be multiplexed at the multiplexing process 335 with information from segmentation/resegmentation and concatenation process 330-b. The multiplexed information may be grouped as a MAC PDU transport block 345. The MAC PDU transport block 345 may be sent through a HARQ procedure 355 to ensure proper transmission of information.

HARQ procedure 355 may transmit a MAC PDU ACK/NACK 350 (e.g., if the MAC PDU is properly/improperly transmitted) to the multiplexing process 335. The multiplexing process 335 may then send the MAC PDU ACK/NACK 350 to retransmission manager 325-a. Retransmission manager 325-a may use the previously stored PDCP PDU information and perform ARQ or HARQ, resegment the information and retransmit it to ensure appropriate transmission of the MAC PDU. Retransmission manager 325-a may send the PDCP PDU delivery notification to PDCP entity 315-a in the PDCP layer 305. Similarly, if the information in the MAC PDU transport block 345 is related to information which originated from PDCP entity 315-b, the MAC PDU ACK/NACK 350 may be directed to PDCP entity 315-b and sent through retransmission manager 325-b.

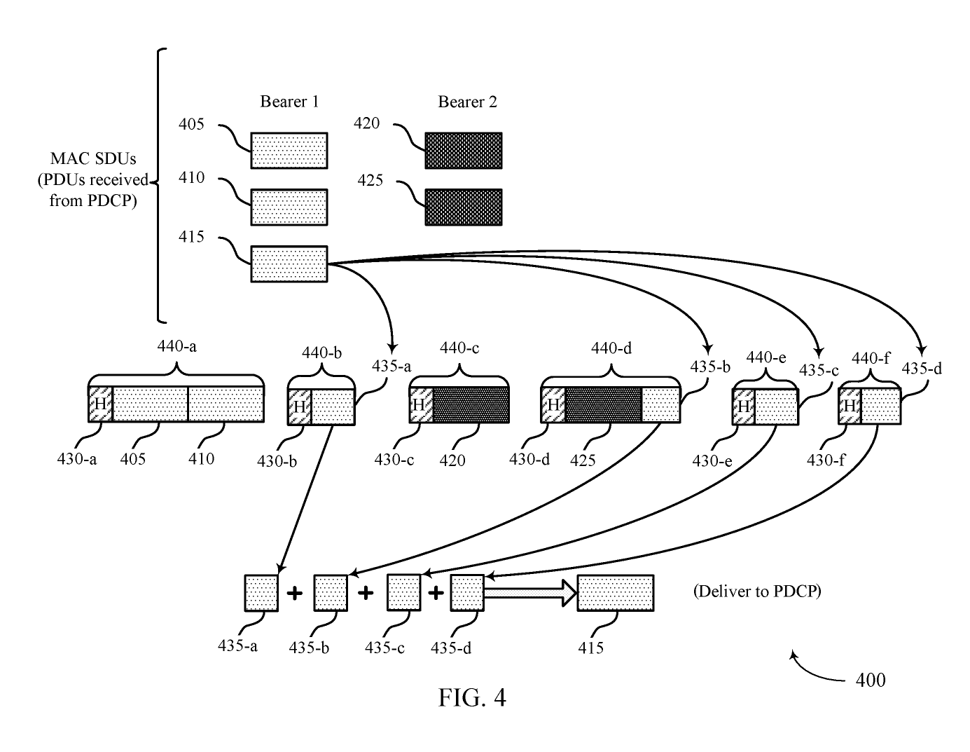

FIG. 4 illustrates an example of MAC SDU segmentation and reassembly and PDCP delivery notification 400 with an eCC in accordance with various aspects of the present disclosure. MAC SDU segmentation and reassembly and PDCP delivery notification 400 may represent communications between a UE 115 and a base station 105 as described with reference to FIGS. 1-2.

MAC SDU segmentation and reassembly and PDCP delivery notification 400 may depict a method of transmitting MAC transport blocks in the absence of an RLC layer and may incorporate segmentation/resegmentation and concatenation functions from protocol stack 300. MAC SDU segmentation and reassembly and PDCP delivery notification 400 may include transmitting header information for each MAC transport block, and the MAC transport blocks may contain entire MAC SDUs or, in some cases, portions of a MAC SDU. The MAC transport blocks may contain MAC SDUs from various sources or bearers. For example, one bearer may provide a MAC SDU 405, a MAC SDU 410, and a MAC SDU 415. Another bearer may provide a MAC SDU 420 and a MAC SDU 425. Some MAC SDUs may be sent as a single transmission, but some MAC SDUs may also be segmented into smaller pieces.

Transport blocks may carry a variety of sizes of information. Some transport blocks may contain, for example, portions of a MAC SDU, a whole MAC SDU, multiple MAC SDUs, or any combination thereof. For example, header information 430-a may provide header information for MAC transport block 440-a containing the MAC SDU 405 and first MAC SDU 410. MAC transport block 440-a may contain the entire MAC SDU 405 and the entire MAC SDU 410. Transport block 440-a may be delivered to the PDCP without any segmentation or reassembly. After transport block 440-a is transmitted, the MAC layer may receive an ACK/NACK indicating the transmission's success or failure.

MAC SDUs from a variety of bearers may be handled in similar fashion. For example, the MAC SDU 420 may be from a different bearer than the MAC SDU 405. The MAC SDU 420 may be sent in transport block 440-c. Transport block 440-c may contain header information 430-c alongside the MAC SDU 420. Header information 430-c may include information regarding which bearer the MAC SDU 420 is from. The entire MAC SDU 420 may be transmitted within the transport block 440-c. The MAC layer may then receive an ACK/NACK after transmitting the transport block 440-c.

In some cases, a MAC SDU is segmented into multiple transport blocks. For example, the MAC SDU 415 may be segmented into multiple segments, such as MAC SDU segment 435-a, MAC SDU segment 435-b, MAC SDU segment 435-c, and MAC SDU segment 435-d. MAC SDU segments may be transmitted as the only non-header information within a MAC transport block, or they may be combined with other MAC SDU information. For example, MAC SDU segment 435-a may be transmitted in MAC transport block 440-b. MAC transport block 440-b may include header information 430-b containing information regarding MAC transport block 440-b.

Header information 430-b may include information such as a segmentation flag, which may indicate that the information within transport block 440-b contains segmented information. The header information may also include a tag number which corresponds to the SDU from which the information in transport block 440-b originated, specifically, in this case, the MAC SDU 415. The header information may also include a segment number, which may allow the receiver to assemble the segments in order. Header information 430-b may also include framing information, which may indicate whether the first and the last byte of the payload corresponds to a segmented SDU.

A MAC SDU segment may also be transmitted with other MAC SDU information, for example in transport block 440-d. Transport block 440-d may contain the entire MAC SDU 425 from one bearer and MAC SDU segment 435-b, originating from the MAC SDU 415, from a different bearer. Header information 430-d may include information regarding the MAC SDU information from the two different bearers. For instance, it may indicate that transport block 440-d may contain information from two different bearers, that transport block 440-d may contain MAC SDU segment 435-b, and, more specifically, information regarding MAC SDU segment 435-b similar to the information described in header information 430-b.

Transport block 440-e and transport block 440-f may include MAC SDU segments 435-c and 435-d respectively. These transport blocks may be similar to transport block 440-b, in that transport blocks 440-e and 440-f may include header information 430-e and header information 430-f respectively. The header information may include information similar to header information 430-b, such as a segmentation flag, a tag number, a segment number, and framing information.

When the segments of a MAC SDU, for example all of the segments of the MAC SDU 415, are received and acknowledged by the receiver, reassembly of the MAC SDU segments may begin. The receiver may use the information stored in the header information of the MAC SDU segments to reconstruct the original MAC SDU. For example, the receiver may reassemble MAC SDU segment 435-a, MAC SDU segment 435-b, MAC SDU segment 435-c, and MAC SDU segment 435-d to reconstruct MAC SDU 415. The receiver may have received the MAC SDU segments out of order, and may utilize the segmentation flag, tag number, segment number, and framing information to properly reassemble the SDU. After reassembling each MAC SDU, it may be delivered to a PDCP layer.

Thus, the transmitting device may receive a first PDCP PDU at a MAC layer of the transmitter, and may generate a set of transport blocks at the MAC layer using the first PDCP PDU. The transmitting device may transmit the transport blocks. In some examples, generating the transport blocks includes generating a first transport block that includes a first portion of the first PDCP PDU and a second transport block that includes a second portion of the first PDCP PDU.

In some cases, the transmitting device may receive a second PDCP PDU at the MAC layer of the transmitter, such that one transport block includes the second PDCP PDU. The transmitting device may receive a second PDCP PDU at the MAC layer of the transmitter, such that one transport block includes a portion of the first PDCP PDU and a portion of the second PDCP PDU.

The transmitting device may store information at the transmitter that indicates a mapping between each transport block that includes a portion of the first PDCP PDU. The transmitting device may receive at the MAC layer an ACK or NACK for each transport block that includes a portion of the first PDCP PDU. The transmitting device may indicate to a PDCP layer that the first PDCP PDU was successfully received or unsuccessfully received based on receiving the ACK or NACK.

In some examples, each transport block includes a header that indicates that the transport block includes a PDCP PDU segment or a non-segmented PDCP PDU. The header may indicate that the transport block includes a PDCP PDU segment, and the header may include a tag number that identifies a complete PDCP PDU to which the PDCP PDU segment corresponds. In some examples, the header indicates that the transport block includes a PDCP PDU segment, and the header may include a segment number that identifies an ordering of the PDCP PDU segment with respect to other segments of the complete PDCP PDU.

In some examples, the segment number indicates an offset of the PDCP PDU segment relative to a beginning of the complete PDCP PDU. The header may indicate that the transport block includes a PDCP PDU segment, and the header may include a framing indicator that identifies the PDCP PDU segment as containing an initial portion, one or more intermediate portions, or a last portion of the complete PDCP PDU. In some cases, generating the transport blocks includes generating a first transport block that includes a first portion of the first PDCP PDU and a second transport block that includes a second portion of the first PDCP PDU.

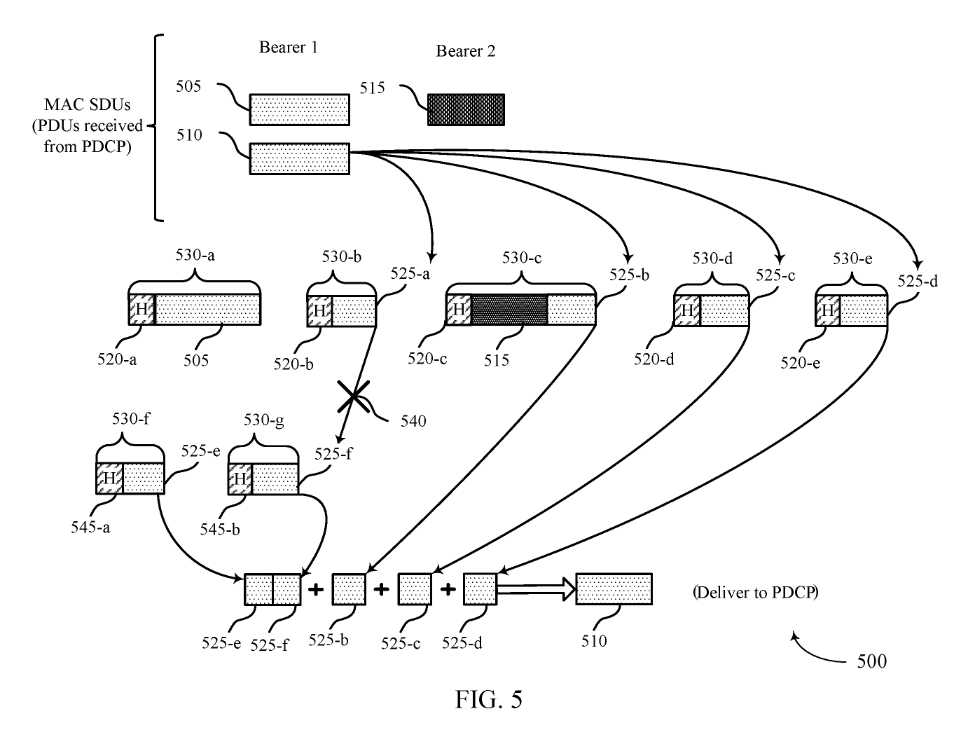

FIG. 5 illustrates an example of MAC SDU segmentation and reassembly and PDCP delivery notification 500 with an eCC in accordance with various aspects of the present disclosure. MAC SDU segmentation and reassembly and PDCP delivery notification 500 may represent communications between wireless devices such as a UE 115 and a base station 105 as described with reference to FIGS. 1-2.

MAC SDU segmentation and reassembly and PDCP delivery notification 500 may depict a method of delivering MAC transport blocks and incorporate segmentation and reassembly procedures as depicted in FIG. 4. MAC SDU segmentation and reassembly and PDCP delivery notification 500 may also relate to cases where a MAC transport block is resegmented. For example, a MAC transport block may be resegmented because the MAC terminates a previous HARQ process because the modulation and coding scheme was changed, or various other reasons. In this case, a MAC SDU segment may be resegmented and re-delivered in a subsequent transport block.

A MAC SDU 505 may be included in transport block 530-a alongside header information 520-a. The header information may include information regarding the MAC SDU 505, and transport block 530-a may be delivered to the PDCP layer. This may reflect similar operations performed in the MAC SDU segmentation and reassembly as depicted in FIG. 4.

As in FIG. 4, a MAC SDU 510 may be segmented into several MAC SDU segments, for example MAC SDU segment 525-a, MAC SDU segment 525-b, MAC SDU segment 525-c and MAC SDU segment 525-d. MAC SDU segment 525-b may be sent alongside a MAC SDU 515 in transport block 530-c. Transport block 530-c may include header information for both MAC SDU segment 525-b and the MAC SDU 515. MAC SDU segment 525-c may be sent in transport block 530-d with header information 520-d. Similarly, MAC SDU segment 525-d may be sent in transport block 530-e with header information 520-e.

In some cases, a transport block may not be properly received by a receiver. For example, transport block 530-b may not be properly received by the receiver, and the receiver may transmit a NACK signal 540 to indicate that transport block 530-b was not properly received. In some cases, the receiver may still find it appropriate to acquire MAC SDU segment 525-a. The receiver may transmit a NACK signal 540 to indicate that transport block 530-b was not properly received. In this case, MAC SDU segment 525-a may be resegmented into MAC SDU segment 525-e and MAC SDU segment 525-f. The MAC SDU segments may be transmitted again in two new transport blocks, transport block 530-f and transport block 530-g.

The header information for the new, resegmented MAC SDU segment 525-e in transport block 530-f may include new information alongside information reused from header information 520-b. New header information 545-a may include a resegmentation flag, a tag number, segment number, and framing info, a resegmentation offset, and a last segment flag. The resegmentation flag may identify that resegmentation of the previously segmented MAC SDU segment 525-a occurred. The tag number, segment number, and framing info may be the same as the information in header information 520-b. The resegmentation offset may be an offset, sometimes in bytes, of the starting position of resegmented transport block 530-f within original transport block 530-b. The last segment flag may identify the last SDU information of MAC SDU 505 originally sent in and resegmented from transport block 530-g. Similar information may be included in new header information 545-b for MAC SDU segment 525-f of transport block 530-g.

When all of the MAC SDU segments have been properly transmitted, they may be reassembled at the receiver. For example, MAC SDU segment 525-b, MAC SDU segment 525-c, MAC SDU segment 525-d, and resegmented MAC SDU segments 525-e and 525-f may be combined to recreate the MAC SDU 510. The MAC SDU 510 then may be delivered, for example to the PDCP layer. The MAC SDU segments may be reassembled based on the sequence number and offset indication retrieved from the header information of each transport block.

Thus, the transmitting device may generate a third transport block that includes a first segment of the first portion of the first PDCP PDU and a fourth transport block that includes a second segment of the first portion of the first PDCP PDU. In some cases, the third and fourth transport blocks each include a header that indicates that they contain a segmented portion of the first PDCP PDU. In some examples, the header of each transport block includes a tag number that identifies the first portion of the first PDCP PDU. The header of each transport block may include a segment number that identifies an ordering of the first and second segments of the first portion of the first PDCP PDU. For instance, the segment numbers may indicate an offset relative to a beginning of the first portion of the first PDCP PDU. In some examples, the header includes a framing indicator that identifies a segment as containing an initial portion, one or more intermediate portions, or a last portion of the first PDCP PDU. The third transport block may be generated based on a terminated HARQ process or a changed modulation and coding scheme (MCS).

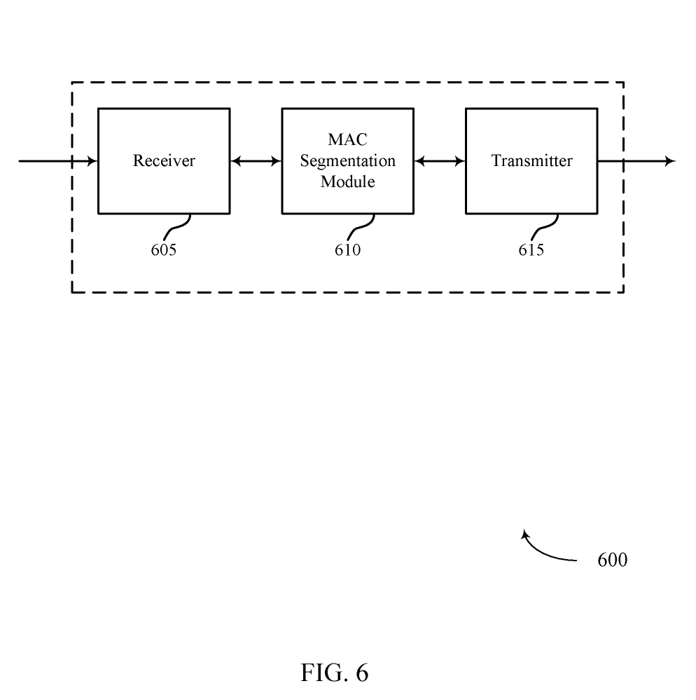

FIG. 6 shows a block diagram of a wireless device 600 that supports MAC segmentation and PDCP delivery notification with an eCC in accordance with various aspects of the present disclosure. Wireless device 600 may be an example of aspects of a UE 115 described with reference to FIGS. 1-5. Wireless device 600 may include a receiver 605, a MAC segmentation module 610, or a transmitter 615. Wireless device 600 may also include a processor. Each of these components may be in communication with one another.

The receiver 605 may receive information such as packets, user data, or control information associated with various information channels (e.g., control channels, data channels, and information related to MAC segmentation and PDCP delivery notification with an eCC, etc.). Information may be passed on to the MAC segmentation module 610, and to other components of wireless device 600. In some examples, the receiver 605 may receive a set of transport blocks at a MAC layer of a receiver.

The MAC segmentation module 610 may receive a first PDCP PDU at a MAC layer of a transmitter, generate a set of transport blocks at the MAC layer using the first PDCP PDU, and transmit the transport blocks.

The transmitter 615 may transmit signals received from other components of wireless device 600. In some examples, the transmitter 615 may be collocated with the receiver 605 in a transceiver module. The transmitter 615 may include a single antenna, or it may include a plurality of antennas. In some examples, the transmitter 615 may transmit the transport blocks.

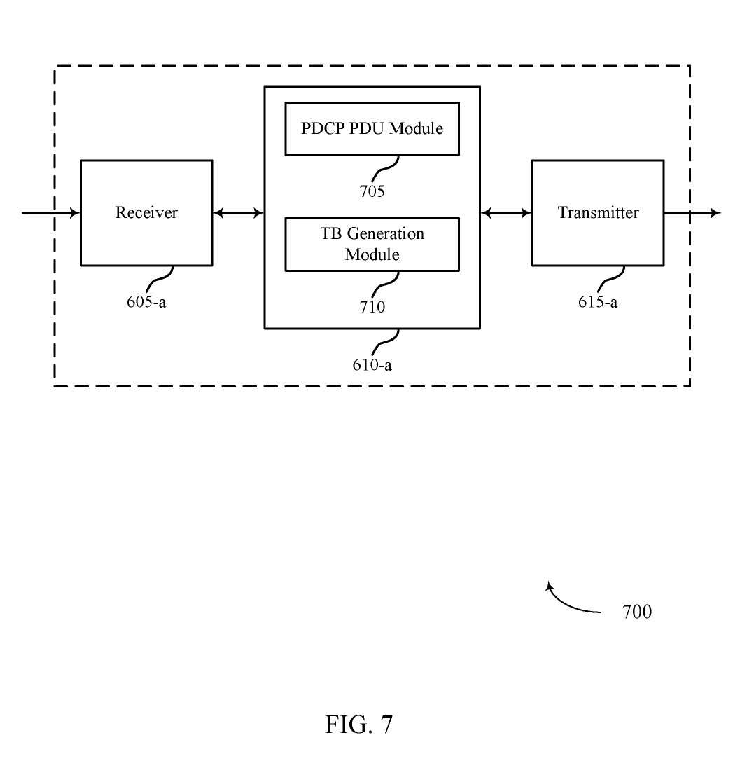

FIG. 7 shows a block diagram of a wireless device 700 that supports MAC segmentation and PDCP delivery notification with an eCC in accordance with various aspects of the present disclosure. Wireless device 700 may be an example of aspects of a wireless device 600 or a UE 115 described with reference to FIGS. 1-6. Wireless device 700 may include a receiver 605-a, a MAC segmentation module 610-a, or a transmitter 615-a. Wireless device 700 may also include a processor. Each of these components may be in communication with each other. The MAC segmentation module 610-a may also include a PDCP PDU module 705, and a TB generation module 710.

The receiver 605-a may receive information, which may be passed on to MAC segmentation module 610-a, and to other components of wireless device 700. The MAC segmentation module 610-a may perform the operations described with reference to FIG. 6. The transmitter 615-a may transmit signals received from other components of wireless device 700.

The PDCP PDU module 705 may receive a first PDCP PDU at a MAC layer of a transmitter as described with reference to FIGS. 2-5. The PDCP PDU module 705 may also receive a second PDCP PDU at the MAC layer of the transmitter, and one transport block may include the second PDCP PDU. The PDCP PDU module 705 may also receive a second PDCP PDU at the MAC layer of the transmitter, where one transport block may include a portion of the first PDCP PDU and a portion of the second PDCP PDU.

The TB generation module 710 may generate a set of transport blocks at the MAC layer using the first PDCP PDU as described with reference to FIGS. 2-5. In some examples, generating the transport blocks includes generating a first transport block that includes a first portion of the first PDCP PDU and a second transport block that includes a second portion of the first PDCP PDU. Each transport block may include a header that indicates that the transport block includes a PDCP PDU segment or a non-segmented PDCP PDU. In some examples, the header indicates that the transport block includes a PDCP PDU segment, and the header includes a tag number that identifies a complete PDCP PDU to which the PDCP PDU segment corresponds.

The header may indicate that the transport block includes a PDCP PDU segment, and the header may include a segment number that identifies an ordering of the PDCP PDU segment with respect to other segments of the complete PDCP PDU. In some examples, the segment number indicates an offset of the PDCP PDU segment relative to a beginning of the complete PDCP PDU. In some examples, the header indicates that the transport block includes a PDCP PDU segment, and the header includes a framing indicator that identifies the PDCP PDU segment as containing an initial portion, one or more intermediate portions, or a last portion of the complete PDCP PDU. In some cases, generating the transport blocks includes generating a first transport block that includes a first portion of the first PDCP PDU and a second transport block that includes a second portion of the first PDCP PDU.

The TB generation module 710 may also generate a third transport block that includes a first segment of the first portion of the first PDCP PDU and a fourth transport block that includes a second segment of the first portion of the first PDCP PDU. In some examples, the third and fourth transport blocks each include a header that indicates that they contain a segmented portion of the first PDCP PDU. In some cases, the third transport block may be generated based on a terminated HARQ process or a changed MCS. The header of each transport block includes a tag number that identifies the first portion of the first PDCP PDU. The header of each transport block may include a segment number that identifies an ordering of the first and second segments of the first portion of the first PDCP PDU.

In some examples, the segment numbers indicate an offset relative to a beginning of the first portion of the first PDCP PDU. In some examples, the header includes a framing indicator that identifies a segment as containing an initial portion, one or more intermediate portions, or a last portion of the first PDCP PDU.

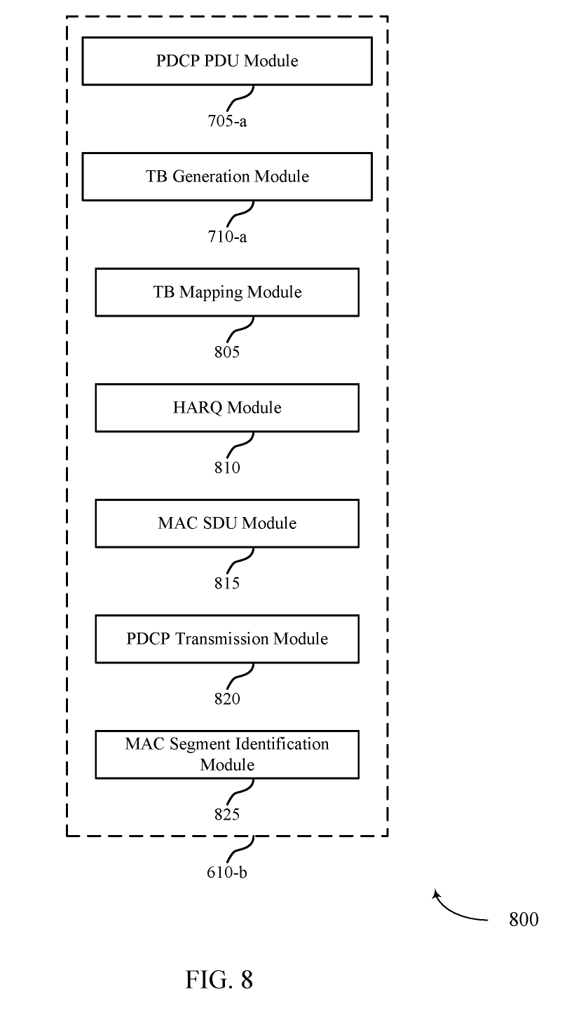

FIG. 8 shows a block diagram 800 of a MAC segmentation module 610-b, which may be a component of a wireless device 600 or a wireless device 700 that supports MAC segmentation and PDCP delivery notification with an eCC in accordance with various aspects of the present disclosure. The MAC segmentation module 610-b may be an example of aspects of a MAC segmentation module 610 described with reference to FIGS. 6-7. The MAC segmentation module 610-b may include a PDCP PDU module 705-a, and a TB generation module 710-a. Each of these modules may perform the functions described with reference to FIG. 7. The MAC segmentation module 610-b may also include a TB mapping module 805, a HARQ module 810, a MAC SDU module 815, a PDCP transmission module 820, and a MAC segment identification module 825.

The TB mapping module 805 may store information at the transmitter that indicates a mapping between each transport block that includes a portion of the first PDCP PDU as described with reference to FIGS. 2-5.

The HARQ module 810 may receive, at the MAC layer of the transmitter, an ACK or NACK for each transport block that includes a portion of the first PDCP PDU as described with reference to FIGS. 2-5. The HARQ module 810 may also indicate to a PDCP layer that the first PDCP PDU was successfully received or unsuccessfully received based on receiving the ACK or NACK.

The MAC SDU module 815 may generate a MAC SDU from the transport blocks as described with reference to FIGS. 2-5. The PDCP transmission module 820 may transmit the MAC SDU to a PDCP layer of the receiver as described with reference to FIGS. 2-5.

The MAC segment identification module 825 may be configured such that generating the MAC SDU may include identifying a first portion of the MAC SDU in a first transport block and a second portion of the MAC SDU in a second transport block as described with reference to FIGS. 2-5. In some examples, the first portion of the MAC SDU may be identified based on a header of the first transport block and the second portion of the MAC SDU may be identified based on a header of the second transport block. The headers of the first and second transport blocks may each include a tag number that identifies the MAC SDU.

In some examples, the headers of the first and second transport blocks include segment numbers that identify an ordering of the first and second portions of the MAC SDU. The header of the first or second transport block may include an indicator of an offset of the first portion or the second portion of the MAC SDU relative to a beginning of the MAC SDU or an indicator that identifies an initial portion, one or more intermediate portions, or a last portion of the MAC SDU. In some examples, the header of the first or second transport block includes an indication that the first portion or the second portion of the MAC SDU may be a resegmented portion of the MAC SDU.

The components of wireless device 600, wireless device 700, and MAC segmentation module 610 may, individually or collectively, be implemented with at least one application specific integrated circuit (ASIC) adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

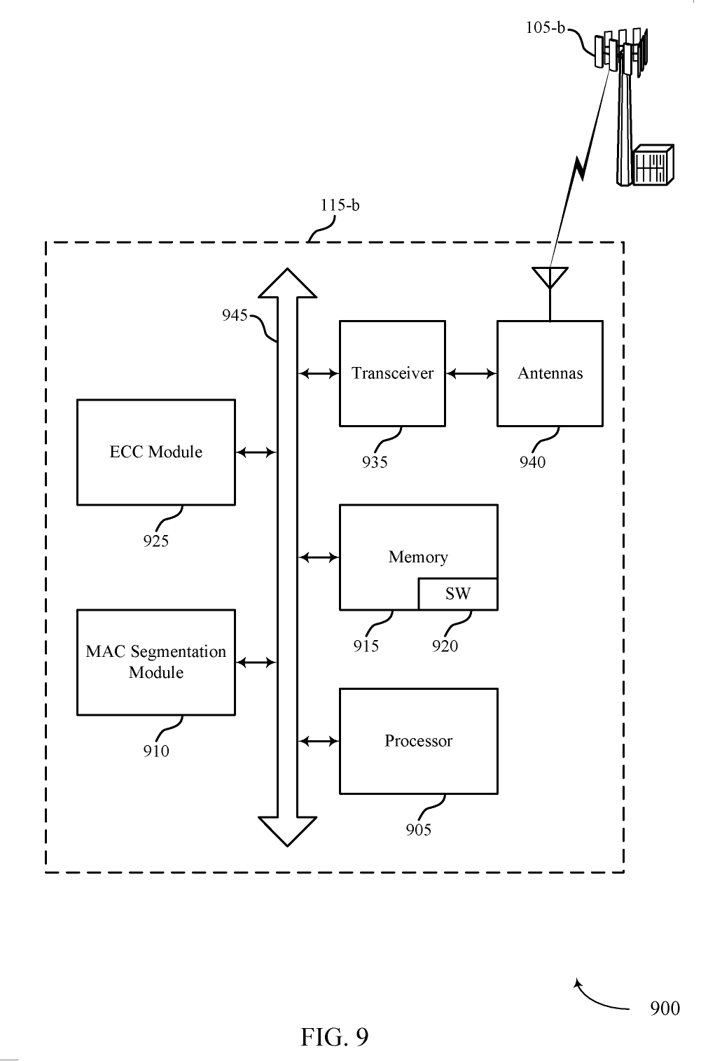

FIG. 9 shows a diagram of a system 900, including a UE 115 that supports MAC segmentation and PDCP delivery notification with an eCC in accordance with various aspects of the present disclosure. System 900 may include UE 115-b, which may be an example of a wireless device 600, a wireless device 700, or a UE 115 described with reference to FIGS. 1, 2 and 6-8. UE 115-b may include a MAC segmentation module 910, which may be an example of a MAC segmentation module 610 described with reference to FIGS. 6-8. UE 115-b may also include an eCC module 925, which may enable eCC operation such as operation in unlicensed spectrum, using variable length TTIs, or with a large number of component carriers. UE 115-b may also include components for bi-directional voice and data communications including components for transmitting communications and components for receiving communications. For example, UE 115-b may communicate bi-directionally with base station 105-b.

UE 115-b may also include a processor 905, and memory 915 (including software (SW) 920), a transceiver 935, and one or more antenna(s) 940, each of which may communicate, directly or indirectly, with one another (e.g., via buses 945). The transceiver 935 may communicate bi-directionally, via the antenna(s) 940, wired links or wireless links, with one or more networks, as described above. For example, the transceiver 935 may communicate bi-directionally with a base station 105 or another UE 115. The transceiver 935 may include a modem to modulate the packets and provide the modulated packets to the antenna(s) 940 for transmission, and to demodulate packets received from the antenna(s) 940. While UE 115-b may include a single antenna 940, UE 115-b may also have multiple antennas 940 capable of concurrently transmitting or receiving multiple wireless transmissions.

The memory 915 may include random access memory (RAM) and read only memory (ROM). The memory 915 may store computer-readable, computer-executable software/firmware code 920 including instructions that, when executed, cause the processor 905 to perform various functions described herein (e.g., MAC segmentation and PDCP delivery notification with an eCC, etc.). Alternatively, the software/firmware code 920 may not be directly executable by the processor 905 but cause a computer (e.g., when compiled and executed) to perform functions described herein. The processor 905 may include an intelligent hardware device, (e.g., a central processing unit (CPU), a microcontroller, ASIC, etc.)

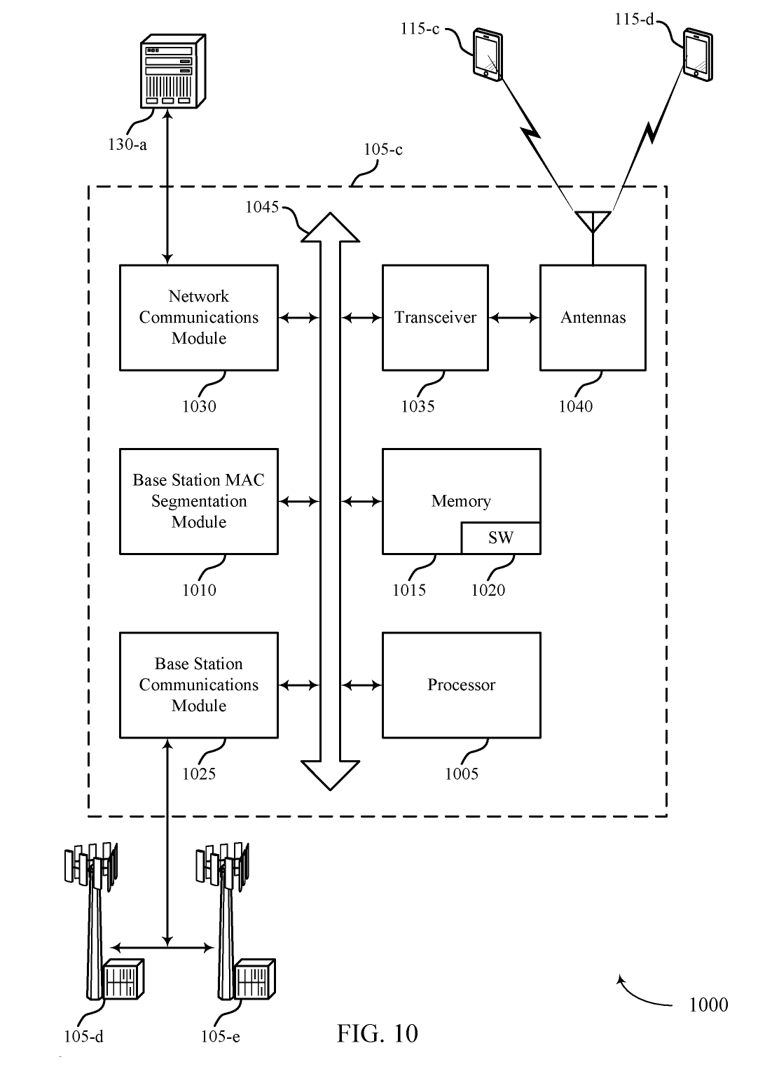

FIG. 10 shows a diagram of a system 1000, including abase station 105 that supports MAC segmentation and PDCP delivery notification with an eCC in accordance with various aspects of the present disclosure. System 1000 may include base station 105-c, which may be an example of a wireless device 600, a wireless device 700, or a base station 105 described with reference to FIGS. 1, 2 and 7-9. Base station 105-c may include a base station MAC segmentation module 1010, which may be an example of a base station MAC segmentation module 1010 described with reference to FIGS. 7-9. Base station 105-c may also include components for bi-directional voice and data communications including components for transmitting communications and components for receiving communications. For example, base station 105-c may communicate bi-directionally with UE 115-c or UE 115-d.

In some cases, base station 105-c may have one or more wired backhaul links. Base station 105-c may have a wired backhaul link (e.g., S1 interface, etc.) to the core network 130. Base station 105-c may also communicate with other base stations 105, such as base station 105-d and base station 105-e via inter-base station backhaul links (e.g., an X2 interface). Each of the base stations 105 may communicate with UEs 115 using the same or different wireless communications technologies. In some cases, base station 105-c may communicate with other base stations such as 105-d or 105-e utilizing base station communications module 1025. In some examples, base station communications module 1025 may provide an X2 interface within a Long Term Evolution (LTE)/LTE-A wireless communication network technology to provide communication between some of the base stations 105. In some examples, base station 105-c may communicate with other base stations through core network 130. In some cases, base station 105-c may communicate with the core network 130 through network communications module 1030.

The base station 105-c may include a processor 1005, memory 1015 (including software (SW) 1020), transceiver 1035, and antenna(s) 1040, which each may be in communication, directly or indirectly, with one another (e.g., over bus system 1045). The transceivers 1035 may be configured to communicate bi-directionally, via the antenna(s) 1040, with the UEs 115, which may be multi-mode devices. The transceiver 1035 (or other components of the base station 105-c) may also be configured to communicate bi-directionally, via the antennas 1040, with one or more other base stations (not shown). The transceiver 1035 may include a modem configured to modulate the packets and provide the modulated packets to the antennas 1040 for transmission, and to demodulate packets received from the antennas 1040. The base station 105-c may include multiple transceivers 1035, each with one or more associated antennas 1040. The transceiver may be an example of a combined receiver 605 and transmitter 615 of FIG. 6.

The memory 1015 may include RAM and ROM. The memory 1015 may also store computer-readable, computer-executable software code 1020 containing instructions that are configured to, when executed, cause the processor 1005 to perform various functions described herein (e.g., MAC segmentation and PDCP delivery notification with an eCC, selecting coverage enhancement techniques, call processing, database management, message routing, etc.). Alternatively, the software code 1020 may not be directly executable by the processor 1005 but be configured to cause the computer, e.g., when compiled and executed, to perform functions described herein. The processor 1005 may include an intelligent hardware device, e.g., a CPU, a microcontroller, an ASIC, etc. The processor 1005 may include various special purpose processors such as encoders, queue processing modules, base band processors, radio head controllers, digital signal processor (DSPs), and the like.

The base station communications module 1025 may manage communications with other base stations 105. In some cases, a communications management module may include a controller or scheduler for controlling communications with UEs 115 in cooperation with other base stations 105. For example, the base station communications module 1025 may coordinate scheduling for transmissions to UEs 115 for various interference mitigation techniques such as beamforming or joint transmission.

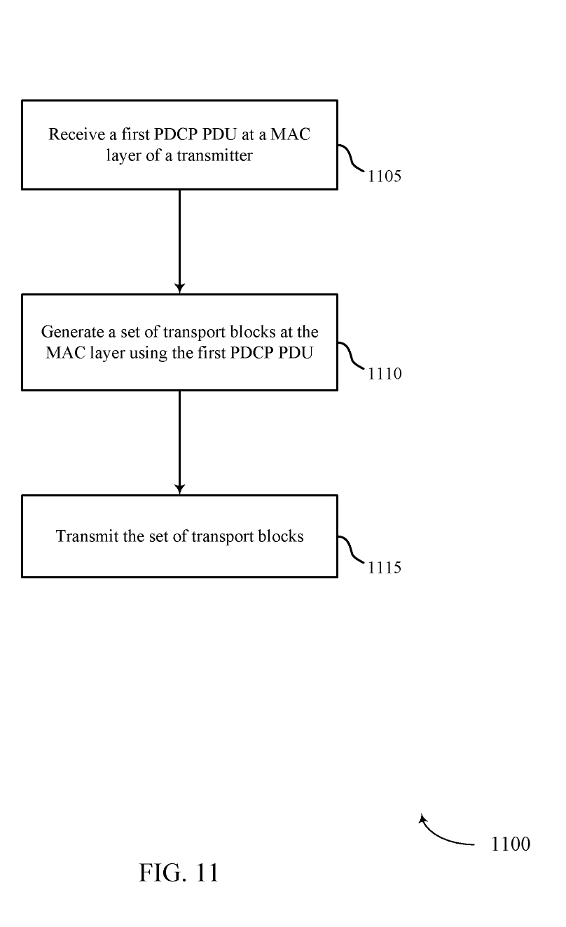

FIG. 11 shows a flowchart illustrating a method 1100 for MAC segmentation and PDCP delivery notification in accordance with various aspects of the present disclosure. The operations of method 1100 may be implemented by a UE 115 or base station 105 or its components as described with reference to FIGS. 1-10. For example, the operations of method 1100 may be performed by the MAC segmentation module 610 as described with reference to FIGS. 6-9. In some examples, a UE 115 or base station 105 may execute a set of codes to control the functional elements of the UE 115 or base station 105 to perform the functions described below. Additionally or alternatively, the UE 115 or base station 105 may perform aspects the functions described below using special-purpose hardware.

At block 1105, the UE 115 or base station 105 may receive a first PDCP PDU at a MAC layer of a transmitter as described with reference to FIGS. 2-5. In certain examples, the operations of block 1105 may be performed by the PDCP PDU module 705 as described with reference to FIG. 7.

At block 1110, the UE 115 or base station 105 may generate a set of transport blocks at the MAC layer using the first PDCP PDU as described with reference to FIGS. 2-5. In certain examples, the operations of block 1110 may be performed by the TB generation module 710 as described with reference to FIG. 7.

At block 1115, the UE 115 or base station 105 may transmit the transport blocks as described with reference to FIGS. 2-5. In certain examples, the operations of block 1115 may be performed by the transmitter 615 as described with reference to FIG. 6.

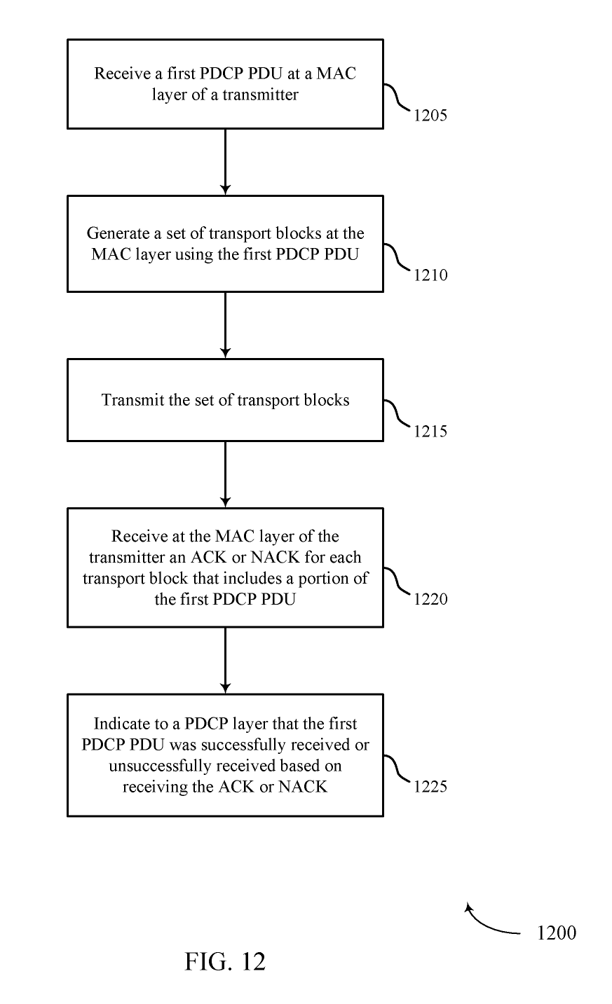

FIG. 12 shows a flowchart illustrating a method 1200 for MAC segmentation and PDCP delivery notification in accordance with various aspects of the present disclosure. The operations of method 1200 may be implemented by a UE 115 or base station 105 or its components as described with reference to FIGS. 1-10. For example, the operations of method 1200 may be performed by the MAC segmentation module 610 as described with reference to FIGS. 6-9. In some examples, a UE 115 or base station 105 may execute a set of codes to control the functional elements of the UE 115 or base station 105 to perform the functions described below. Additionally or alternatively, the UE 115 or base station 105 may perform aspects the functions described below using special-purpose hardware. The method 1200 may also incorporate aspects of method 1100 of FIG. 11.

At block 1205, the UE 115 or base station 105 may receive a first PDCP PDU at a MAC layer of a transmitter as described with reference to FIGS. 2-5. In certain examples, the operations of block 1205 may be performed by the PDCP PDU module 705 as described with reference to FIG. 7.

At block 1210, the UE 115 or base station 105 may generate a set of transport blocks at the MAC layer using the first PDCP PDU as described with reference to FIGS. 2-5. In certain examples, the operations of block 1210 may be performed by the TB generation module 710 as described with reference to FIG. 7.

At block 1215, the UE 115 or base station 105 may transmit the transport blocks as described with reference to FIGS. 2-5. In certain examples, the operations of block 1215 may be performed by the transmitter 615 as described with reference to FIG. 6.

At block 1220, the UE 115 or base station 105 may receive at the MAC layer of the transmitter an ACK or NACK for each transport block that includes a portion of the first PDCP PDU as described with reference to FIGS. 2-5. In certain examples, the operations of block 1220 may be performed by the HARQ module 810 as described with reference to FIG. 8.

At block 1225, the UE 115 or base station 105 may indicate to a PDCP layer that the first PDCP PDU was successfully received or unsuccessfully received based on receiving the ACK or NACK as described with reference to FIGS. 2-5. In certain examples, the operations of block 1225 may be performed by the HARQ module 810 as described with reference to FIG. 8.

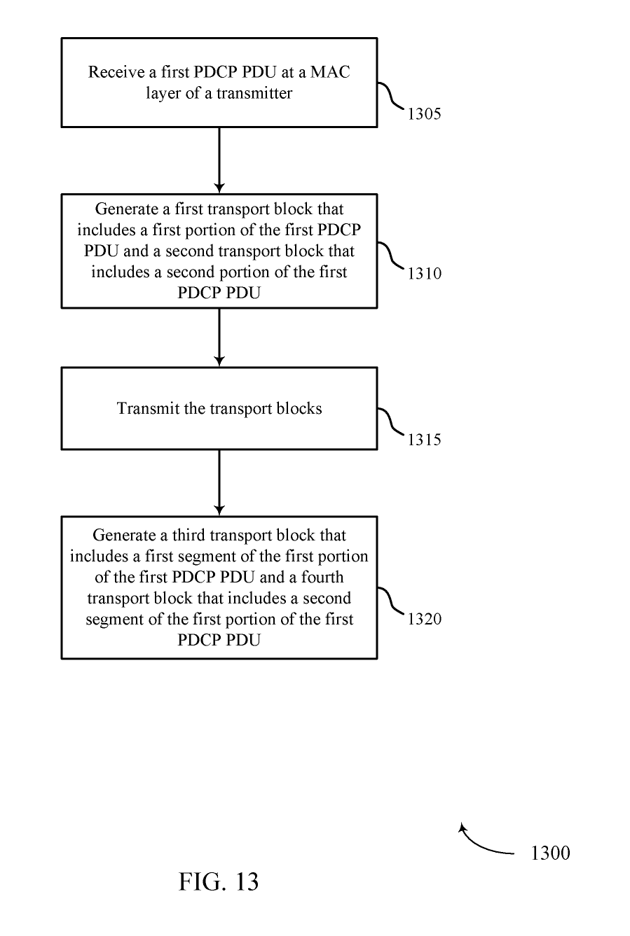

FIG. 13 shows a flowchart illustrating a method 1300 for MAC segmentation and PDCP delivery notification in accordance with various aspects of the present disclosure. The operations of method 1300 may be implemented by a UE 115 or base station 105 or its components as described with reference to FIGS. 1-10. For example, the operations of method 1300 may be performed by the MAC segmentation module 610 as described with reference to FIGS. 6-9. In some examples, a UE 115 or base station 105 may execute a set of codes to control the functional elements of the UE 115 or base station 105 to perform the functions described below. Additionally or alternatively, the UE 115 or base station 105 may perform aspects the functions described below using special-purpose hardware. The method 1300 may also incorporate aspects of methods 1100, and 1200 of FIGS. 11-12.

At block 1305, the UE 115 or base station 105 may receive a first PDCP PDU at a MAC layer of a transmitter as described with reference to FIGS. 2-5. In certain examples, the operations of block 1305 may be performed by the PDCP PDU module 705 as described with reference to FIG. 7.

At block 1310, the UE 115 or base station 105 may generate a set of transport blocks at the MAC layer using the first PDCP PDU as described with reference to FIGS. 2-5. In some cases, generating the transport blocks includes generating a first transport block that includes a first portion of the first PDCP PDU and a second transport block that includes a second portion of the first PDCP PDU. In certain examples, the operations of block 1310 may be performed by the TB generation module 710 as described with reference to FIG. 7.

At block 1315, the UE 115 or base station 105 may transmit the transport blocks as described with reference to FIGS. 2-5. In certain examples, the operations of block 1315 may be performed by the transmitter 615 as described with reference to FIG. 6.

At block 1320, the UE 115 or base station 105 may generate a third transport block that includes a first segment of the first portion of the first PDCP PDU and a fourth transport block that includes a second segment of the first portion of the first PDCP PDU as described with reference to FIGS. 2-5. In certain examples, the operations of block 1320 may be performed by the TB generation module 710 as described with reference to FIG. 7.

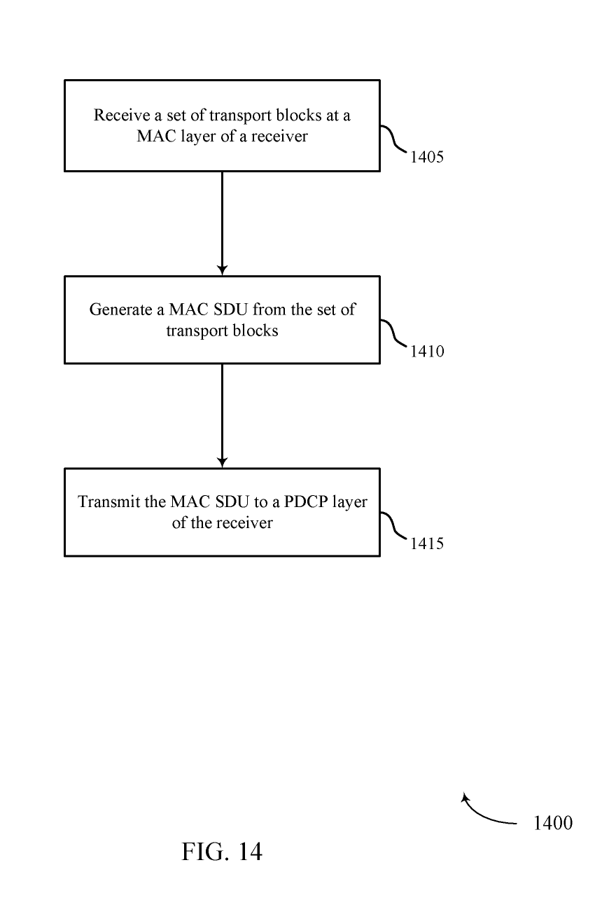

FIG. 14 shows a flowchart illustrating a method 1400 for MAC segmentation and PDCP delivery notification in accordance with various aspects of the present disclosure. The operations of method 1400 may be implemented by a UE 115 or base station 105 or its components as described with reference to FIGS. 1-10. For example, the operations of method 1400 may be performed by the MAC segmentation module 610 as described with reference to FIGS. 6-9. In some examples, a UE 115 or base station 105 may execute a set of codes to control the functional elements of the UE 115 or base station 105 to perform the functions described below. Additionally or alternatively, the UE 115 or base station 105 may perform aspects the functions described below using special-purpose hardware.

At block 1405, the UE 115 or base station 105 may receive a set of transport blocks at a MAC layer of a receiver as described with reference to FIGS. 2-5. In certain examples, the operations of block 1405 may be performed by the receiver 605 as described with reference to FIG. 6.

At block 1410, the UE 115 or base station 105 may generate a MAC SDU from the transport blocks as described with reference to FIGS. 2-5. In certain examples, the operations of block 1410 may be performed by the MAC SDU module 815 as described with reference to FIG. 8.

At block 1415, the UE 115 or base station 105 may transmit the MAC SDU to a PDCP layer of the receiver as described with reference to FIGS. 2-5. In certain examples, the operations of block 1415 may be performed by the PDCP transmission module 820 as described with reference to FIG. 8.

Thus, methods 1100, 1200, 1300, and 1400 may provide for MAC segmentation and PDCP delivery notification with an eCC. It should be noted that methods 1100, 1200, 1300, and 1400 describe possible implementation, and that the operations and the steps may be rearranged or otherwise modified such that other implementations are possible. In some examples, aspects from two or more of the methods 1100, 1200, 1300, and 1400 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, Universal Mobile Telecommunications System (UMTS), LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for frequency division duplex (FDD) (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on, or transmitted over, as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
receiving a first packet data convergence protocol (PDCP) protocol data unit (PDU) at a media access control (MAC) layer of a transmitter;
generating a set of transport blocks at the MAC layer using the first PDCP PDU; and
transmitting the set of transport blocks.

2. The method of claim 1, wherein generating the set of transport blocks comprises:
generating a first transport block that comprises a first portion of the first PDCP PDU and a second transport block that comprises a second portion of the first PDCP PDU.

3. The method of claim 1, further comprising:
receiving a second PDCP PDU at the MAC layer of the transmitter, wherein one transport block of the set of transport blocks comprises the second PDCP PDU.

4. The method of claim 1, further comprising:
receiving a second PDCP PDU at the MAC layer of the transmitter, wherein one transport block of the set of transport blocks comprises a portion of the first PDCP PDU and a portion of the second PDCP PDU.

5. The method of claim 1, further comprising:
storing information at the transmitter that indicates a mapping between each transport block of the set of transport blocks that comprises a portion of the first PDCP PDU.

6. The method of claim 1, further comprising:
receiving at the MAC layer of the transmitter an acknowledgement (ACK) or negative acknowledgement (NACK) for each transport block of the set of transport blocks that comprises a portion of the first PDCP PDU; and
indicating to a PDCP layer that the first PDCP PDU was successfully received or unsuccessfully received based at least in part on receiving the ACK or NACK.

7. The method of claim 1, wherein each transport block of the set of transport blocks comprises a header that indicates that the transport block comprises a PDCP PDU segment or a non-segmented PDCP PDU.

8. The method of claim 7, wherein the header indicates that the transport block comprises a PDCP PDU segment, and wherein the header comprises a tag number that identifies a complete PDCP PDU to which the PDCP PDU segment corresponds.

9. The method of claim 8, wherein the header indicates that the transport block comprises a PDCP PDU segment, and wherein the header comprises a segment number that identifies an ordering of the PDCP PDU segment with respect to other segments of the complete PDCP PDU.

10. The method of claim 9, wherein the segment number indicates an offset of the PDCP PDU segment relative to a beginning of the complete PDCP PDU.

11. The method of claim 8, wherein the header indicates that the transport block comprises a PDCP PDU segment, and wherein the header comprises a framing indicator that identifies the PDCP PDU segment as containing an initial portion, a middle portion or a last portion of the complete PDCP PDU.

12. The method of claim 1, wherein generating the set of transport blocks comprises:
generating a first transport block that comprises a first portion of the first PDCP PDU and a second transport block that comprises a second portion of the first PDCP PDU; and
generating a third transport block that comprises a first segment of the first portion of the first PDCP PDU and a fourth transport block that comprises a second segment of the first portion of the first PDCP PDU.

13. The method of claim 12, wherein the third transport block and the fourth transport block each comprise a header that indicates that they contain a segmented portion of the first PDCP PDU.

14. The method of claim 13, wherein the header of each transport block comprises a tag number that identifies the first portion of the first PDCP PDU.

15. The method of claim 13, wherein the header of each transport block comprises a segment number that identifies an ordering of the first segment of the first portion of the first PDCP PDU and the second segment of the first portion of the first PDCP PDU.

16. The method of claim 15, wherein the segment number indicates an offset relative to a beginning of the first portion of the first PDCP PDU.

17. The method of claim 13, wherein the header comprises a framing indicator that identifies a segment as containing an initial portion, a middle portion or a last portion of the first PDCP PDU.

18. The method of claim 12, wherein the third transport block is generated based at least in part on a terminated hybrid automatic repeat request (HARQ) process or a changed modulation and coding scheme (MCS).

19. A method of wireless communication, comprising:
receiving a set of transport blocks at a media access control (MAC) layer of a receiver;
generating a MAC service data unit (SDU) from the set of transport blocks; and
transmitting the MAC SDU to a PDCP layer of the receiver.

20. The method of claim 19, wherein generating the MAC SDU comprises:
identifying a first portion of the MAC SDU in a first transport block of the set of transport blocks and a second portion of the MAC SDU in a second transport block of the set of transport blocks.

21. The method of claim 20, wherein the first portion of the MAC SDU is identified based at least in part on a header of the first transport block and the second portion of the MAC SDU is identified based at least in part on a header of the second transport block.

22. The method of claim 21, wherein header of the first transport block and the header of the second transport block each comprise a tag number that identifies the MAC SDU.

23. The method of claim 21, wherein the header of the first transport block and the header of the second transport block comprise segment numbers that identify an ordering of the first portion of the MAC SDU and the second portion of the MAC SDU.

24. The method of claim 21, wherein the header of the first transport block or the header of the second transport block comprises an indicator of an offset of the first portion or the second portion of the MAC SDU relative to a beginning of the MAC SDU or an indicator that identifies an initial portion, a middle portion or a last portion of the MAC SDU.

25. The method of claim 21, wherein the header of the first transport block or the header of the second transport block comprises an indication that the first portion or the second portion of the MAC SDU is a resegmented portion of the MAC SDU.

26. An apparatus for wireless communication, comprising:
a processor;
memory in electronic communication with the processor; and
instructions stored in the memory and operable, when executed by the processor, to cause the apparatus to:
receive a first packet data convergence protocol (PDCP) protocol data unit (PDU) at a media access control (MAC) layer of a transmitter;
generate a set of transport blocks at the MAC layer using the first PDCP PDU; and
transmit the set of transport blocks.

27. The apparatus of claim 26, wherein the instructions are operable to cause the apparatus to:
store information at the transmitter that indicates a mapping between each transport block of the set of transport blocks that comprises a portion of the first PDCP PDU.

28. The apparatus of claim 26, wherein the instructions are operable to cause the apparatus to:
receive at the MAC layer of the transmitter an acknowledgement (ACK) or negative acknowledgement (NACK) for each transport block of the set of transport blocks that comprises a portion of the first PDCP PDU; and
indicate to a PDCP layer that the first PDCP PDU was successfully received or unsuccessfully received based at least in part on receiving the ACK or NACK.

29. The apparatus of claim 26, wherein each transport block of the set of transport blocks comprises a header that indicates that the transport block comprises a PDCP PDU segment or a non-segmented PDCP PDU.

30. An apparatus for wireless communication, comprising:
a processor;
memory in electronic communication with the processor; and
instructions stored in the memory and operable, when executed by the processor, to cause the apparatus to:
receive a set of transport blocks at a media access control (MAC) layer of a receiver;
generate a MAC service data unit (SDU) from the set of transport blocks; and
transmit the MAC SDU to a PDCP layer of the receiver.
